(19) United States
(12) Patent Application Publication
(10) Pub. No.: US 2025/0243395 A1
(43) Pub. Date: Jul. 31, 2025

(54) ORGANIC GEL PHASE CHANE MATERIAL WITH DOUBLE CROSSLINKED NETWORK AND PREPARATION METHOD

(71) Applicant: Shanghai Shengsheng Logistics Co., LTD., Shanghai (CN)

(72) Inventors: YUCHEN ZHANG, Shanghai (CN); YUNLONG GUO, Shanghai (CN)

(21) Appl. No.: 18/612,031

(22) Filed: Mar. 21, 2024

(30) Foreign Application Priority Data
Jan. 29, 2024 (CN) 202410116387.0

(51) Int. Cl. C09K 5/06; B29C 39/00; B29C 39/42; B29K 105/00; B29K 105/16; C08J 3/24; C08L 53/00

(52) U.S. Cl. CPC C09K 5/06; B29C 39/003; B29C 39/42; C08J 3/24; C08L 53/00; B29K 2105/0061; B29K 2105/16; B29K 2995/0026; C08J 2353/00; C08J 2409/00; C08J 2453/02

(57) ABSTRACT

An organic gel phase change material with a double crosslinked network and a preparation method thereof are provided, the preparation method includes the following steps: S1, heating and stirring an organic phase change material, completely melting into a transparent liquid; S2. adding an elastomer gel agent material into a melted organic phase change material in batches, heating and stirring until they are completely dissolved into a uniform viscous liquid; S3. adding a crosslinking agent, an UV initiator, and a nucleating agent to the uniform viscous liquid in sequence, stirring until they are completely dissolved; S4. pouring the uniform viscous solution obtained in step S3 into a shaping mold, cooling completely, obtaining an organic gel phase change material with a single crosslinked network; S5. performing a vacuum treatment on an obtained phase change material, UV curing treatment to obtain the organic gel phase change material with a double crosslinked network.

### CROSS-REFERENCE TO RELATED APPLICATIONS

This application claims priority to Chinese Patent Application No. 202410116387.0, filed on Jan. 29, 2024 which is hereby incorporated by reference in its entirety.

### TECHNICAL FIELD

The present disclosure relates to the field of phase change material technologies, and in particular, to an organic gel phase change material with a double crosslinked network and a preparation method thereof.

### BACKGROUND

Phase change materials (PCMs) undergo a phase change at a specific temperature (usually melting or solidification), which can absorb or release a large amount of latent heat, thereby maintaining a relatively stable ambient temperature. They are an ideal thermal management material and are widely used for temperature control in specific situations, such as cold chain transportation. The phase change materials are divided into an organic phase change material and an inorganic phase change material. The inorganic phase change materials include a crystalline hydrated salt, molten salt, alloy, or metal. These materials have high thermal storage density, high thermal conductivity, and are inexpensive. However, they may experience undercooling and phase separation during use, which seriously affects a practical application; the organic phase change materials include a paraffin, fatty acid, some advanced fatty hydrocarbons, alcohol, carboxylic acid, and salt. These materials have small volume changes, thermal conductivity, no supercooling or phase separation during phase change, and they are very promising phase change materials.

In current application scenarios, phase change materials are usually used to maintain temperature stability by melting, absorbing heat, solidifying, and releasing heat. Phase change materials are often in a liquid state during use, so they are usually packaged in a specific sealed container to restrict flow. In the field of cold chain transportation, a commonly used temperature range is 2-8° C. and 20-25° C. Phase change materials in this range are usually organic solvents, the transportation environment is complex, which may cause collision or even drop risks. Once a packaging container is defective or damaged, phase change materials are prone to leakage, which not only affects an insulation time, but also may contaminate goods and cause more serious losses. Therefore, developing an anti-leakage and high latent heat phase change material has great significance in various temperature control situations.

For example, in patent U.S. Pat. No. 9,598,622B2, a gel containing phase change material is disclosed, and a processing method is described. In this patent, the phase change material can include alkanes (such as n-tetradecane, n-hexadecane, n-octadecane or mixtures thereof), a gel agent used therein is a block copolymer of polymer elastomer, preferably SEPS, SEBS, etc. The processing method is to uniformly mix the phase change material and gel agent at a high temperature and then drop them to a room temperature to form gel.

Further, in patent U.S. Pat. No. 9,556,373B2, another processing method of a system is disclosed, which uses phase change materials to swell a gel agent at room temperature, fill it into a closed container, and then conducts heating and annealing operations to achieve a gel. However, the system and method used in the present invention cannot avoid liquid leakage of the phase change gel at a specific temperature; sample prepared by this method has a common strength and is prone to deformation and damage when transporting heavy goods.

On a premise of not losing a latent heat of phase change, the present disclosure develops a new processing method, overcomes liquid leakage phenomenon during a phase change process, improves a compression strength of a flexible organic gel phase change material, and can greatly expand a solvent system of the phase change material.

### SUMMARY

In order to solve the problems in the above background technology, the present disclosure provides an organic gel phase change material with a double crosslinked network and a preparation method thereof. By heating and annealing, a physical crosslinking is initiated, a chemical crosslinking is initiated by ultraviolet irradiation, a flexible organic gel phase change material with high latent heat and no leakage is prepared. In addition, a compression strength of the organic gel phase change material is improved, it is not easy to deform and damage under large cargo loads, and greatly expanded a solvent system of the phase change material.

In order to achieve the above objectives, the present disclosure adopts the following technical solutions.

A first aspect of the present disclosure provides a preparation method of an organic gel phase change material with a double crosslinked network, which includes the following steps:
S1. weighing 80.2-94.4 parts by weight of an organic phase change material, heating and stirring at a temperature of 10° C. higher than a phase change temperature of the organic phase change material, melting completely into a transparent liquid;
S2. weighing 5-18 parts by weight of an elastomer gel material, adding into a melted organic phase change material obtained in step S1 in batches, heating and stirring until they are completely dissolved into a uniform viscous liquid;
S3. weighing 0.5-1.5 parts by weight of a crosslinking agent, 0.05-0.15 parts by weight of an UV initiator, and 0.05-0.15 parts by weight of a nucleating agent, sequentially adding them to the uniform viscous liquid obtained in step S2, stirring until they are completely dissolved;
S4. pouring the uniform viscous solution obtained in step S3 into a shaping mold, maintaining a temperature 10° C. higher than the phase change temperature thereof, cooling completely to obtain an organic gel phase change material with a single crosslinked network;
S5. performing a vacuum treatment on the organic gel phase change material with a single crosslinked network obtained in step S4, then UV curing treatment to finally obtain the organic gel phase change material with a double crosslinked network.

Adopting the above technical solution: in the present disclosure, the organic phase change material is taken as a main body, the physical crosslinking is initiated through the heating and annealing of the elastomer gel material, the physical crosslinking network is constructed. Then, the UV light initiator is used to initiate the chemical crosslinking under the UV light irradiation, the chemical crosslinking network is constructed. The flexible gel phase change material with a stable shape is prepared through an interpenetration of double network, which has excellent anti-leakage effect and reduces a leakage phenomenon in a use process.

In addition, a chemical crosslinking point in the double network system makes the gel phase change material have an excellent toughness, a physical crosslinking point renders the gel phase change material have an excellent rigidity. This synergy makes the gel phase change material have an excellent mechanical property, it is not easy to deform and damage under large cargo loads.

The UV irradiation induces a crosslinking reaction, which has a wide adaptability for the organic phase change material. The solvent system of the organic phase change material can be expanded to a fatty alcohol, fatty acid, and fatty acid ester, except for alkane, and it can be adapted for more application scenarios.

A principle of used gel agent material and crosslinking agent to form a network is simple, it is convenient to processing, the UV light initiation is easy to expand a production scale with a low energy consumption.

The organic phase change material is a mixture of one or more of a linear fatty alkane, unitary fatty alcohol, unitary fatty acid, and long-chain fatty acid ester.

The elastomer gel agent material is a mixture of one or more of a styrene block copolymer, polyolefin elastomer, ethylene propylene diene monomer and cis-1,4-polybutadiene rubber.

In an embodiment of the present disclosure, the styrene block copolymer is a mixture of one or more of a styrene butadiene styrene (SBS) block copolymer, styrene isoprene styrene (SIS) block copolymer, styrene ethylene/butylene styrene (SEBS) block copolymer, and styrene ethylene/propylene styrene (SEPS) block copolymer.

A heating temperature in step S2 is 80-100° C.

In an embodiment of the present disclosure, the heating temperature in step S2 is lower than a flash point of the organic phase change material.

The crosslinking agent is a bifunctional or multifunctional small molecular compound. According to a system of the organic phase change material, a mixture of one or some of diacrylate class or divinyl groups can be selected.

The UV initiator is a mixture of one or more of dibenzoyl, alkylphenylketones and benzoyl phosphine oxide, it is initiated at an initiation wavelength of 254 nm, 395 nm, or a wide wavelength.

The nucleating agent is a high melting point organic matter or a dispersible micron inorganic matter that is fused with the organic phase, for example, tetradecyl alcohol, surface modified micrometer alumina, etc.

A second aspect of the present disclosure provides an organic gel phase change material with a double crosslinked network, which is prepared by the preparation method of an organic gel phase change material with a double crosslinked network.

Compared with existing technology, the present disclosure has the following beneficial effects:
(1) In the present disclosure, the organic gel phase change material has a double network of physical and chemical crosslinking, which takes the organic phase change material as a main body, a physical crosslinking is initiated through heating and annealing of an elastomer gel material, a physical crosslinking network is constructed, an ultraviolet light initiator is used to initiate a chemical crosslinking under an ultraviolet light irradiation, a chemical crosslinking network is constructed, a flexible gel phase change material with a stable shape through an interpenetrating of the double network is obtained, which has an excellent anti-leakage effect and reduces a liquid-leakage phenomenon during use;
(2) a chemical crosslinking point in the double network system renders the gel phase change material have an excellent toughness, a physical crosslinking point renders the gel phase change material have an excellent rigidity. A synergy makes the gel phase change material have an excellent mechanical property, it is not easy to deform and damage under large cargo loads;
(3) the UV irradiation induces a crosslinking reaction, which has a wide adaptability for the organic phase change material. It can expand a solvent system of the organic phase change material to a fatty alcohol, fatty acid, and fatty acid ester, except for alkane, and can be adapted for more application scenarios;
(4) a principle of used gel agent material and crosslinking agent to form a network is simple, it is convenient to processing, easy to expand a production scale by the UV light initiation with a low energy consumption.

### BRIEF DESCRIPTION OF DRAWINGS

Below, a further detailed explanation of the present disclosure will be provided in combination with the drawings and specific embodiments.

FIG. 1 is a physical picture of an organic gel phase change material with a double crosslinked network of n-hexadecane and SEBS-SBS prepared in Example 1.

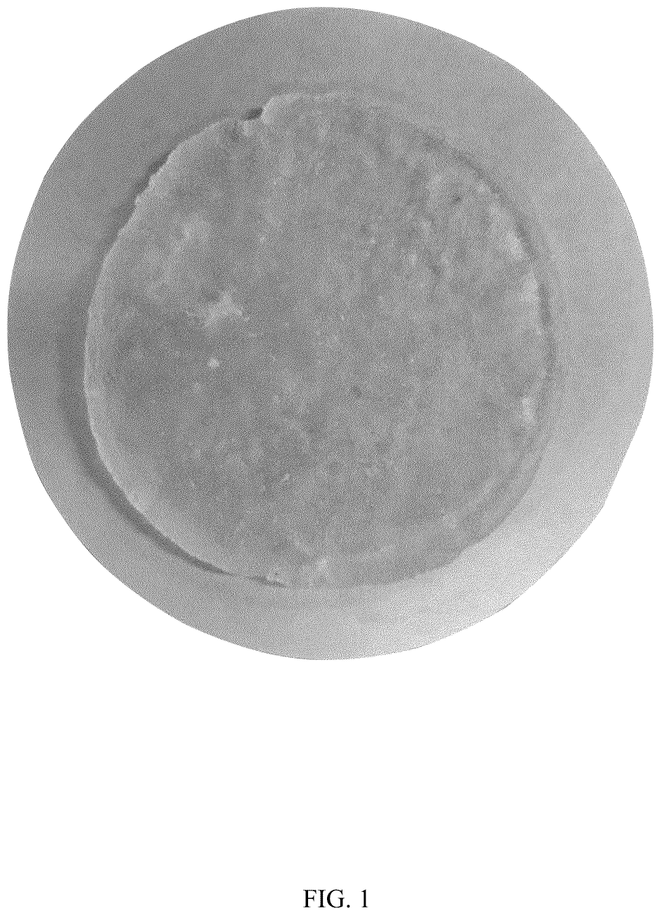

FIG. 2 is a DSC curve diagram of the organic gel phase change material with a double crosslinked network of n-hexadecane and SEBS-SBS prepared in Example 1.

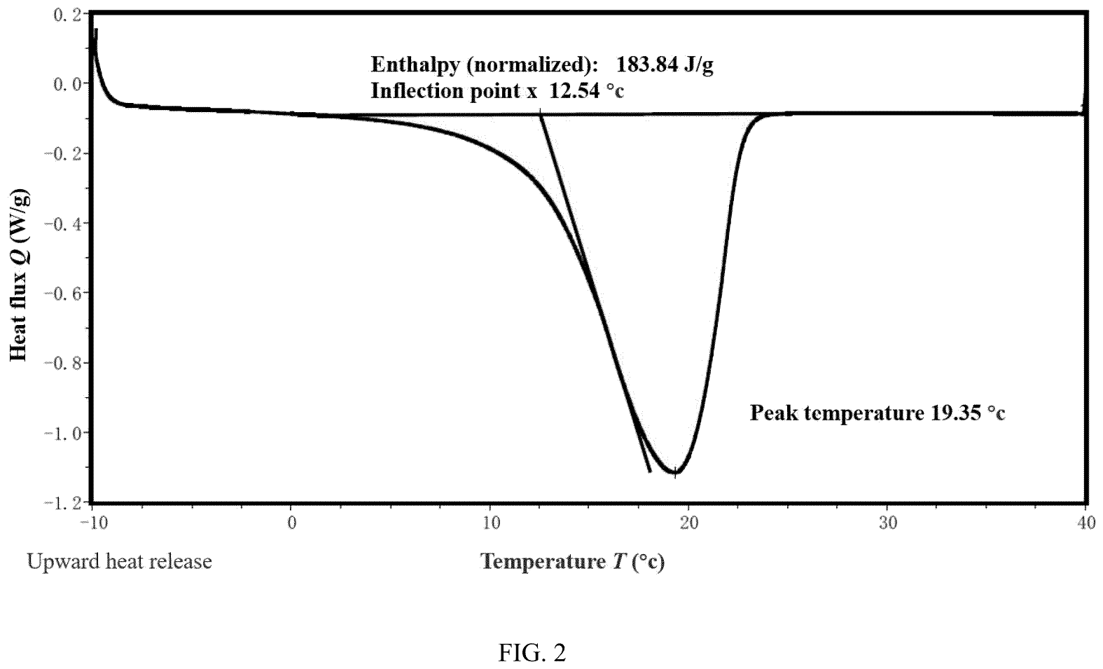

FIG. 3 is a physical picture of the organic gel phase change material with a double crosslinked network of n-hexadecane SEBS and cis-1,4-polybutadiene rubber prepared in Example 2.

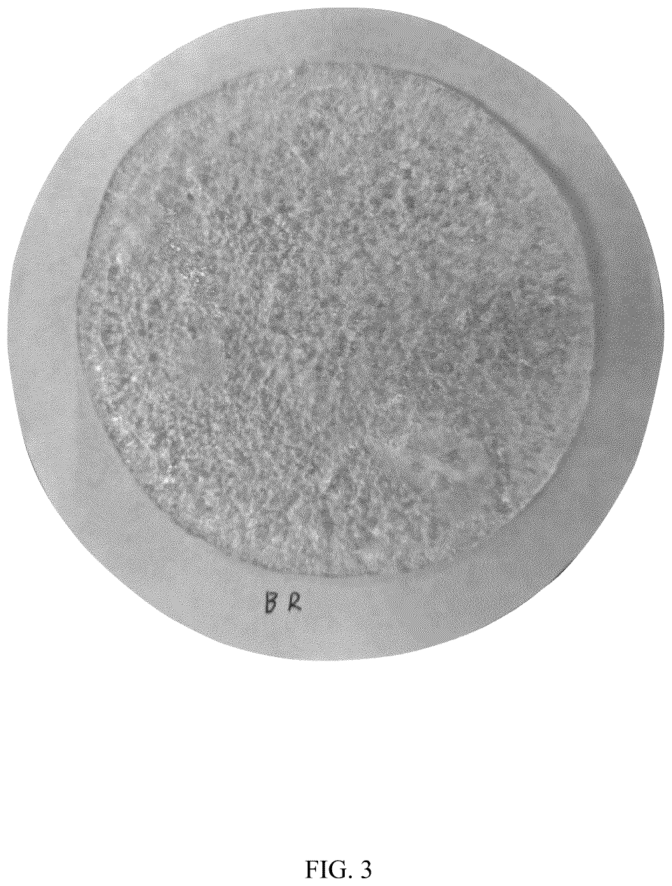

FIG. 4 is a DSC curve diagram of the organic gel phase change material with a double crosslinked network of n-hexadecane SEBS and cis-1,4-polybutadiene rubber prepared in Example 2.

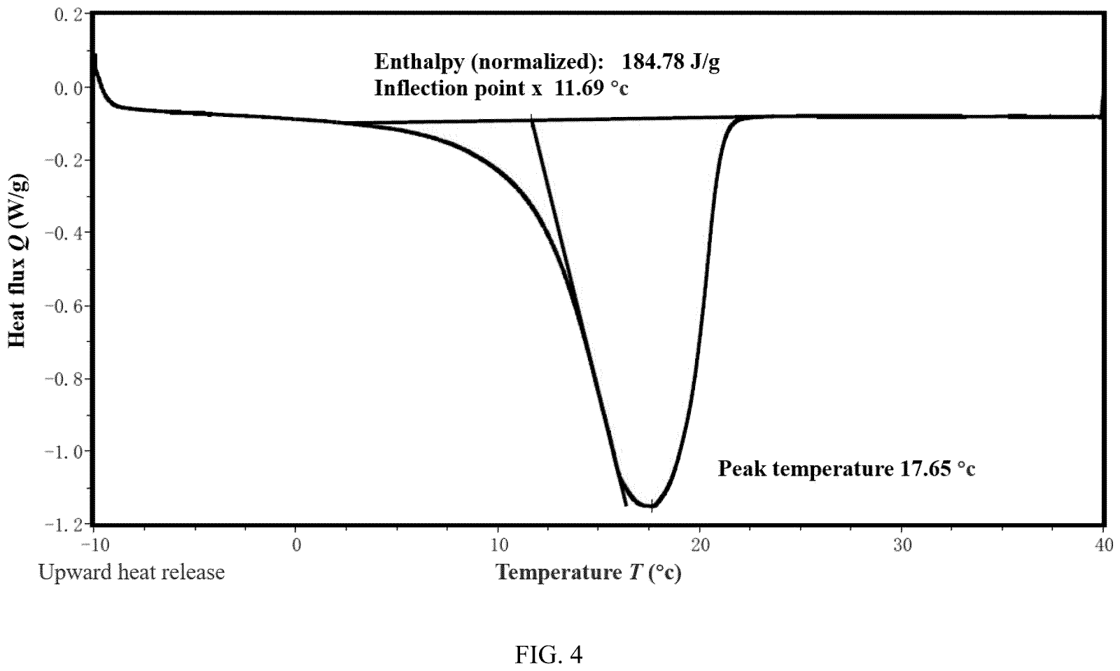

FIG. 5 is a physical picture of the organic gel phase change material with a double crosslinked network of methyl palmitate, SEBS and cis-1,4-polybutadiene rubber prepared in Example 3.

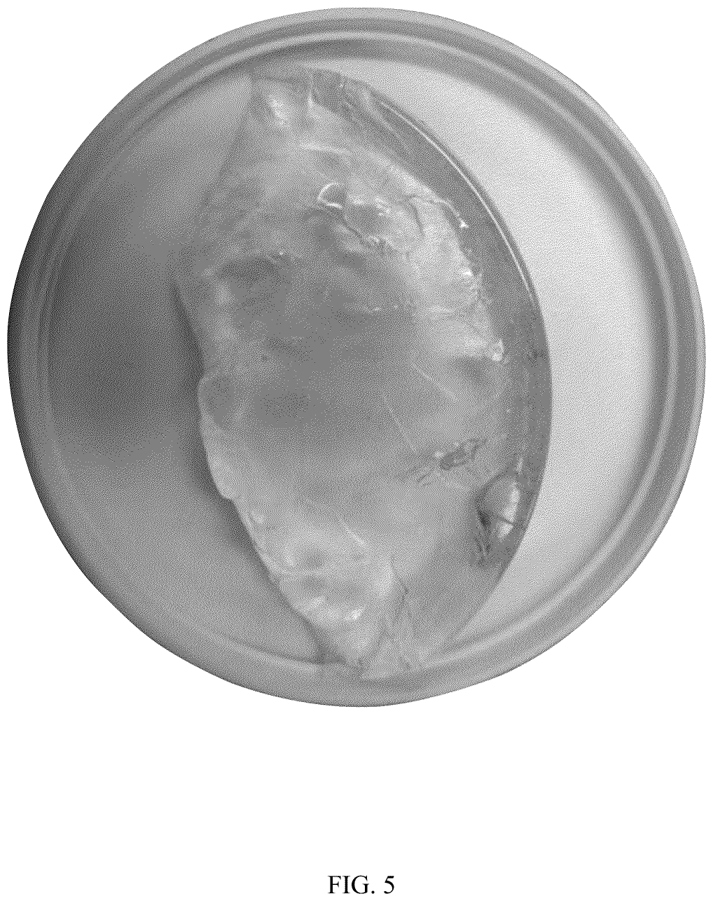

FIG. 6 is a DSC curve diagram of the organic gel phase change material with a double crosslinked network of methyl palmitate, SEBS and cis-1,4-polybutadiene rubber prepared in Example 3.

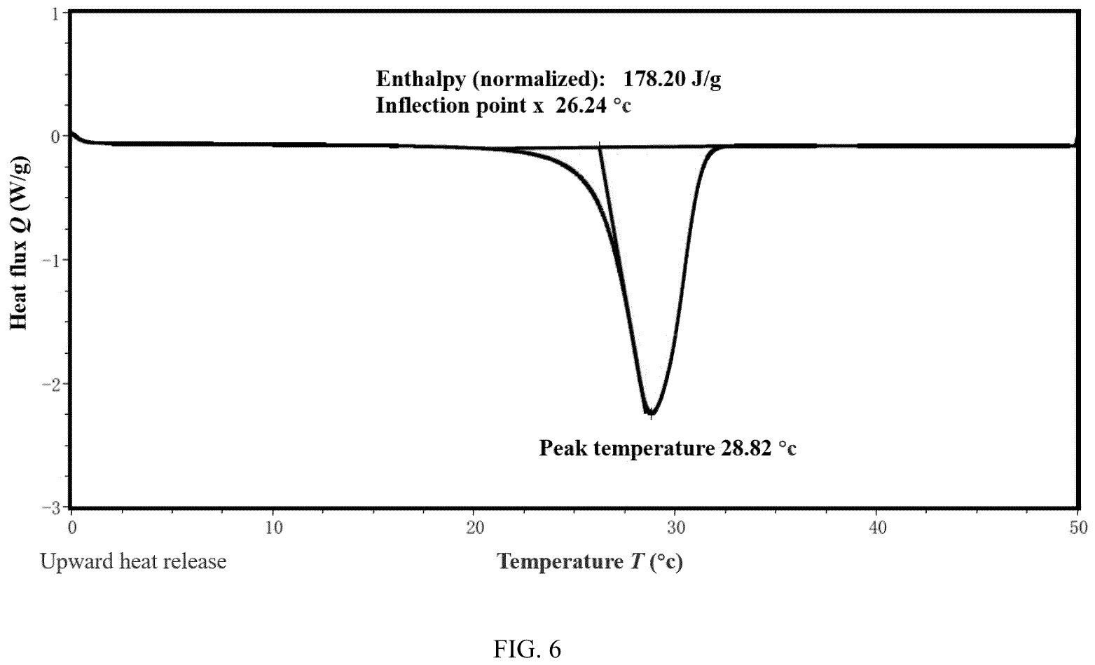

FIG. 7 is a physical picture of an organic gel phase change material with a single crosslinked network of n-hexadecane and SEBS prepared in Comparative Example 1.

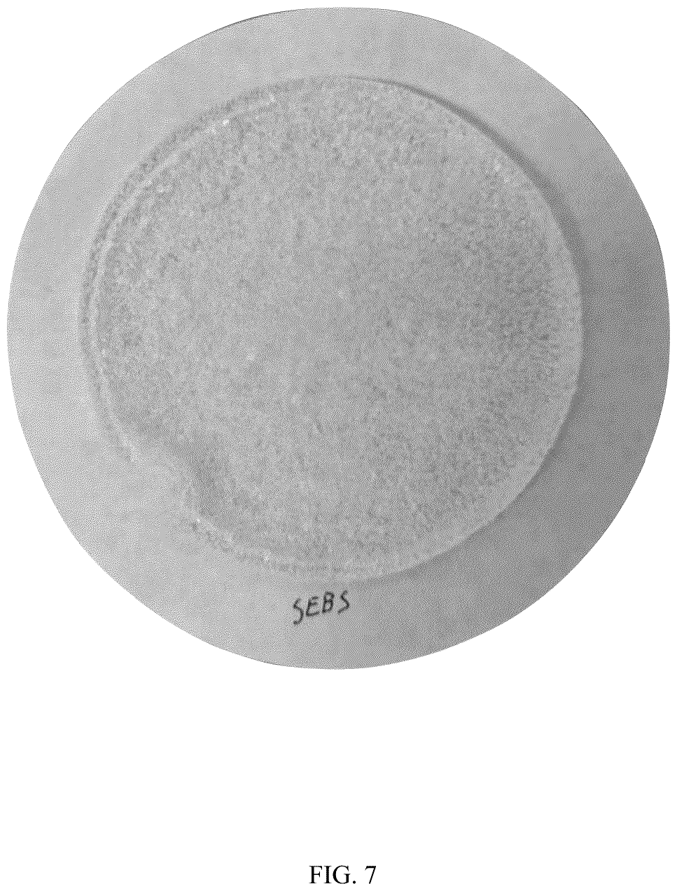

FIG. 8 is a DSC curve diagram of the organic gel phase change material with a single crosslinked network of n-hexadecane and SEBS prepared in Comparative Example 1.

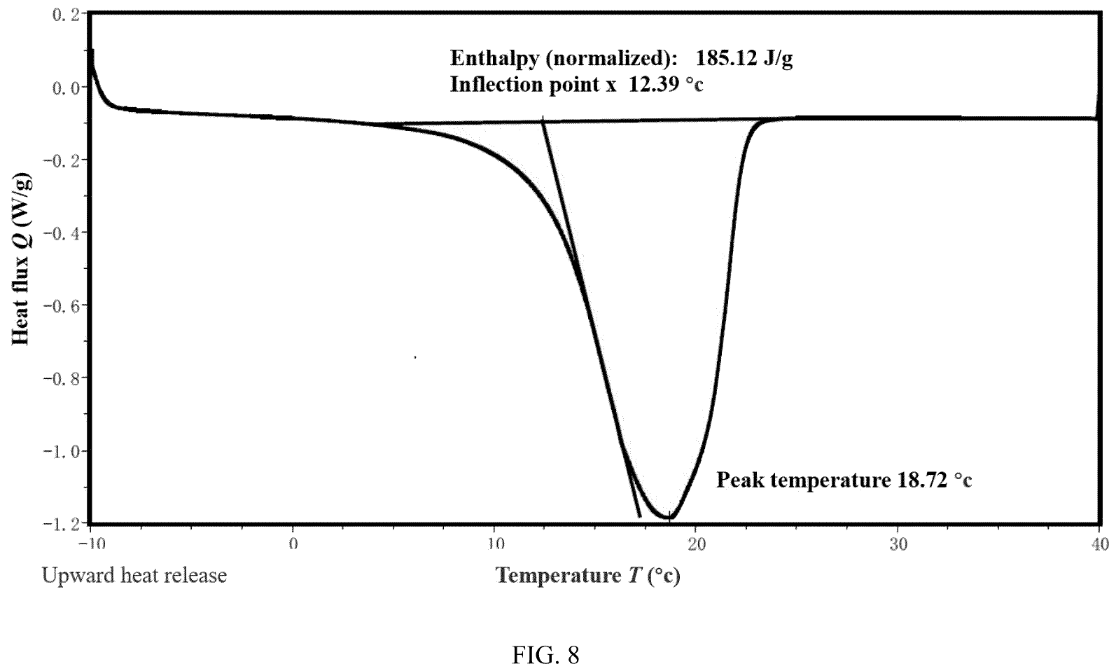

FIG. 9 is a physical picture of the organic phase change material of palm acid methyl ester and SEBS prepared in Comparative Example 2.

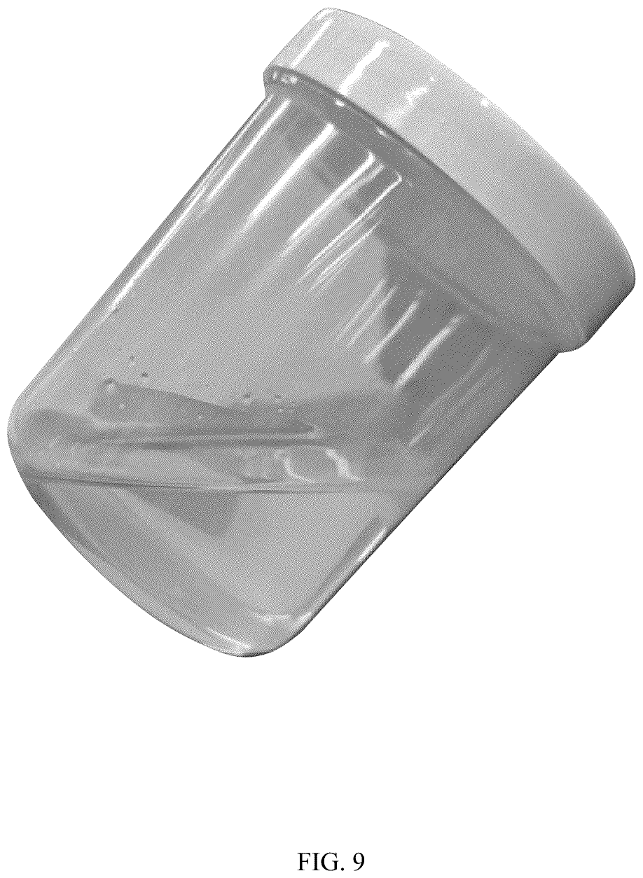

FIG. 10 is a DSC curve diagram of the organic phase change material of palmitic acid methyl ester SEBS prepared in Comparative Example 2.

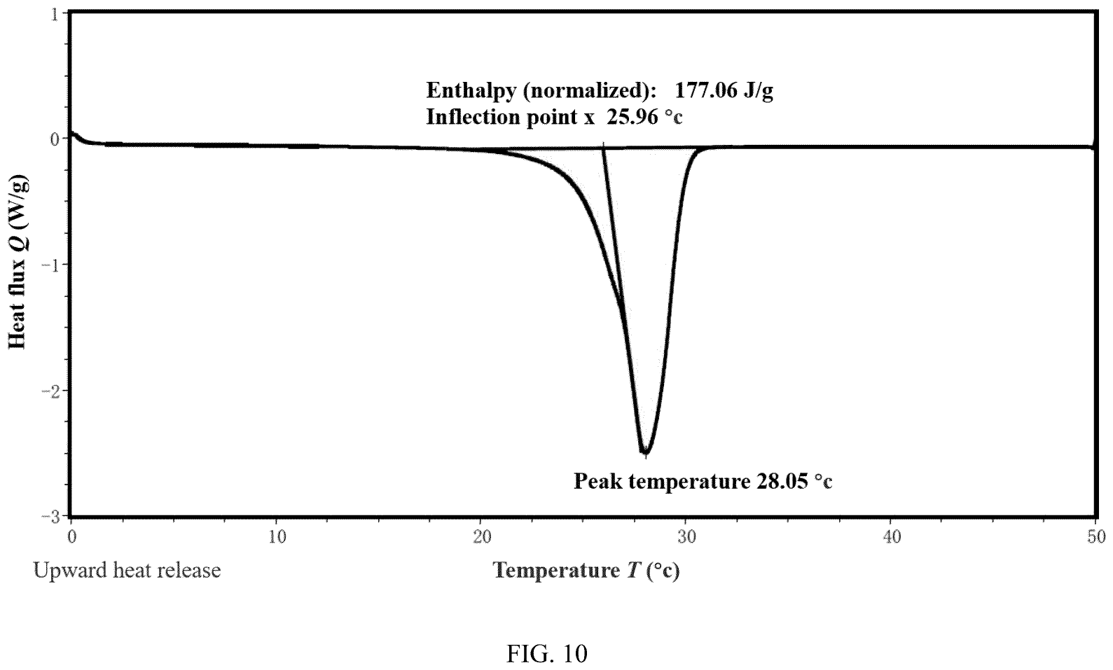

FIG. 11 is a test curve of mechanical properties-compressive strength of material samples in Example 1, Example 2, and Comparative Example 1.

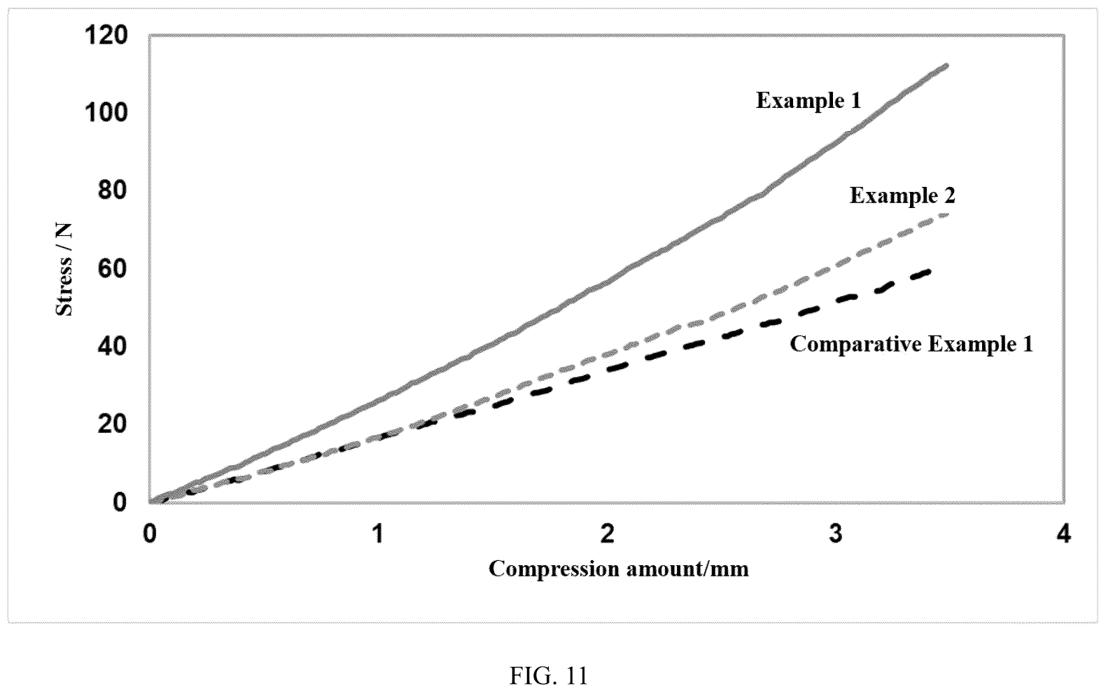

### DESCRIPTION OF EMBODIMENTS

For a convenience of understanding the present disclosure, the following description will provide a more comprehensive and detailed description of the present disclosure in combination with preferred embodiments. However, the protection scope of the present disclosure is not limited to the following specific embodiments.

Unless otherwise defined, all professional terms used in the following description have same meanings as those commonly understood by those skilled in the art. The professional terms used in this specification are only for a purpose of describing specific embodiments and are not intended to limit the protection scope of the present disclosure.

Unless otherwise specified, various reagents and raw materials used in the present disclosure are products that can be purchased from the market or made through well-known methods.

### Example 1

S1. Weighing 44.4 g of n-hexane, pouring it into a flask; heating and stirring in a 30° C. oil bath until completely melted into a transparent liquid;
S2. weighing 3 g of styrene ethylene/butene styrene block copolymer (SEBS) and 2 g of styrene butadiene styrene block copolymer (SBS), respectively, pouring into the flask, adjusting a temperature of the oil bath to 90° C., maintain stirring until a solid is completely dissolved to form a transparent and uniform viscous liquid;
S3. weighing 0.5 g of p-vinylbenzene, 0.05 g of 1-hydroxycyclohexylphenone, and 0.05 g of dodecanol, stirring them in the flask until they are completely dissolved to obtain a uniform and viscous solution;
S4. pouring the uniform viscous solution obtained in step S3 into a glass mold while it is hot, placing it on a 20° C. heating table, cooling to 25° C., then an organic gel phase change material with a single crosslinked network can be shaped;
S5. taking out the organic gel phase change material with a single crosslinked network, a transparent film bag is used to vacuum seal it, putting it into an UV Diplomatic Online, taking it out after crosslinking and curing under 254 nm UV light for 1 hour to prepare the organic gel phase change material with a double crosslinked network.

### Example 2

S1. Weighing 44.4 g of n-hexane, pouring it into a flask, heating and stirring in a 30° C. oil bath until completely melted into a transparent liquid;
S2. weighing 3 g of styrene ethylene/butene styrene block copolymer (SEBS) and 2 g of cis-1,4-polybutadiene rubber, respectively, pouring into the flask, adjusting a temperature of the oil bath to 90° C., maintain stirring until a solid is completely dissolved to form a transparent and uniform viscous liquid;
S3. weighing 0.5 g of p-vinylbenzene, 0.05 g of 1-hydroxycyclohexylphenone, and 0.05 g of n-dodecanol, stirring them in the flask until they are completely dissolved to obtain a uniform and viscous solution;
S4. pouring the uniform viscous solution obtained in step S3 into a glass mold while it is hot, placing it on a 20° C. heating table, cooling to 25° C., then an organic gel phase change material with a single crosslinked network can be shaped;
S5. taking out the organic gel phase change material with a single crosslinked network, a transparent film bag is used to vacuum seal it, putting it into an UV Diplomatic Online, taking it out after crosslinking and curing under 254 nm UV light for 1 hour to prepare the organic gel phase change material with a double crosslinked network.

### Example 3

S1. Weighing 44.4 g of methyl palmitate, pouring it into a flask, heating and stirring in a 30° C. oil bath until completely melted into a transparent liquid;
S2. weighing 2 g of styrene ethylene/butene styrene block copolymer (SEBS) and 3 g of cis-1,4-polybutadiene rubber, respectively, pouring into the flask, adjusting a temperature of the oil bath to 100° C., maintain stirring until a solid is completely dissolved to form a transparent and uniform viscous liquid;
S3. weighing 0.5 g of 1,6-hexanediol diacrylate, 0.05 g of diphenyl (2,4,6-trimethylbenzoyl) phosphine oxide, and 0.05 g of n-tetradecanol, respectively, adding them to the flask, stirring until they are completely dissolved to obtain a uniform and viscous solution;
S4. pouring the uniform viscous solution obtained in step S3 into a glass mold while it is hot, placing it on a 30° C. heating table, cooling to 35° C., then observing its flow state;
S5. taking out the phase change material obtained in step S4, a transparent film bag is used to vacuum seal it, putting it into an UV Diplomacy Online, taking it out after crosslinking and curing under 395 nm ultraviolet light for 1 hour to prepare the organic gel phase change material with a double crosslinked network.

### Comparative Example 1

S1. Weighing 44.95 g of n-hexane, pour it into a flask, heating and stirring in a 30° C. oil bath until completely melted into a transparent liquid;
S2. weighing 5 g of styrene ethylene/butene styrene block copolymer (SEBS) into the flask, adjusting a temperature of the oil bath to 90° C., maintain stirring until a solid is completely dissolved to form a transparent and uniform viscous liquid;
S3. weighing 0.05 g of n-dodecanol, adding it to the flask, stirring until it is uniform;
S4. pouring the solution obtained in step S3 into a glass mold while it is hot, placing it on a 20° C. heating table, cooling to 25° C., then the organic gel phase change material with a single crosslinked network can be shaped.

### Comparative Example 2

S1. Weighing 44.95 g of methyl palmitate, pouring it into a flask, heating and stirring in a 30° C. oil bath until completely melted into a transparent liquid;
S2. weighing 5 g of styrene ethylene/butylene styrene block copolymer (SEBS) into the flask, adjusting a temperature of the oil bath to 100° C., maintain stirring until a solid is completely dissolved to form a transparent and uniform liquid.
S3. weighing 0.05 g of n-tetradecanol, adding it to the flask, stirring until it is uniform;
S4. pouring the solution obtained in step S3 into a glass mold while it is hot, placing it on a 30° C. heating table, cooling to 35° C., then observing its flow state.

Perform various performance tests on material samples prepared in Examples 1-3 and Comparative Example 1 and 2. Specific test results are shown in Tables 1 and 2.

TABLE 1
Parameters Table of Alkanes Examples and Comparative Examples

| | | Phase | | | | |
|---|---|---|---|---|---|---|
| | Phase | change | | Weight | | |
| | transition | enthalpy | Original | after | Mass | Elastic |
| | temperature | value | weight | 30 days | loss | modulus |
| | (° C.) | (J/g) | (g) | (g) | (%) | (N/mm) |
| Example 1 | 15.95 | 183.84 | 47.93 | 46.92 | 2.1 | 32.2 |
| Example 2 | 14.67 | 184.78 | 46.51 | 45.42 | 2.3 | 21.3 |
| Comparative | 15.55 | 185.12 | 46.28 | 44.82 | 3.2 | 17.3 |
| Example 1 | | | | | | |

1. Mass loss test is calculated by placing a sample on qualitative filter paper and weighing its loss mass.
2. The elastic modulus is compressed using a universal material testing machine, with a sample size of 15 cm * 20 cm * 2 cm and a strain being set to 4 mm.

It can be seen from a data comparison in Table 1 that, the mass loss of a gel phase change material formed by using only single-layer physical crosslinked network in the Comparative Example 1 is 3.2% after 48 hours; while Example 1 and Example 2 maintain the same amount of gel agent addition, the mass loss of gel phase change materials prepared using two crosslinked networks (physical crosslinking plus chemical crosslinking) is 2.1% and 2.3% respectively after 48 hours, the leakage is less than that of the Comparative Example 1, an anti-fluid leakage performance is improved by about 30% when the Example 1 and 2 compared with Comparative Example 1. At the same time, there is no significant difference in the phase change temperature and enthalpy of the three, which indicates that the organic gel phase change material with a double network prepared in the present disclosure can effectively inhibit the leakage of the organic gel phase change material with a single network. In the compression performance test, the gel phase change material of the Example 1 effectively increased the elastic modulus by 86.1%, and the gel phase change material of Example 2 increased the elastic modulus by 23.1%, which indicates that the double network structure formed in the present disclosure can greatly improve the mechanical properties of the gel type phase change material, so that it can maintain its shape without deformation and damage under large cargo loads.

TABLE 2
Parameters table of Esters Examples and Comparative Example

| | Phase transition | Phase change enthalpy |
|---|---|---|
| Example | temperature(° C.) | value(J/g) |
| Example 3 | 27.53 | 178.20 |
| Comparative | 27.01 | 177.06 |
| Example 2 | | |

The sample prepared in Comparative Example 2, gel phase change material cannot be formed, it is still a flowing viscous liquid.

It can be seen from the data comparison in Table 2 that, although the phase change temperature and enthalpy of Example 3 and Comparative Example 2 are similar, the sample in the Comparative Example 2 cannot form a gel phase change material, but it is still a flowing viscous liquid. The sample in Example 3 forms a gel phase change material. This comparison shows that the crosslinking method in the present disclosure can be extended to a variety of solution systems.

The above applies specific examples to illustrate the present disclosure, only for a purpose of assisting in understanding the present disclosure, and it is not intended to limit the present disclosure. For those skilled in the technical field to which the present disclosure belongs, based on the ideas of the present disclosure, several simple deductions, deformations, or substitutions can also be made.

What is claimed is:

1. A preparation method of an organic gel phase change material with a double crosslinked network, comprises the following steps:
S1. weighing 80.2-94.4 parts by weight of an organic phase change material, heating and stirring at a temperature of 10° C. higher than a phase change temperature of the organic phase change material, melting completely into a transparent liquid;
S2. weighing 5-18 parts by weight of an elastomer gel material, adding into a melted organic phase change material obtained in step S1 in batches, heating and stirring until they are completely dissolved into a uniform viscous liquid;
S3. weighing 0.5-1.5 parts by weight of a crosslinking agent, 0.05-0.15 parts by weight of an UV initiator, and 0.05-0.15 parts by weight of a nucleating agent, sequentially adding them to the uniform viscous liquid obtained in step S2, stirring until they are completely dissolved;
S4. pouring the uniform viscous solution obtained in step S3 into a shaping mold, maintaining a temperature 10° C. higher than the phase change temperature thereof, cooling completely to obtain an organic gel phase change material with a single crosslinked network;
S5. performing a vacuum treatment on the organic gel phase change material with a single crosslinked network obtained in step S4, then UV curing treatment to finally obtain the organic gel phase change material with a double crosslinked network.

2. The preparation method of an organic gel phase change material with a double crosslinked network according to claim 1, wherein the organic phase change material is a mixture of one or more of a linear fatty alkane, unitary fatty alcohol, unitary fatty acid, and long-chain fatty acid ester.

3. The preparation method of an organic gel phase change material with a double crosslinked network according to claim 1, wherein the elastomer gel agent material is a mixture of one or more of a styrene block copolymer, polyolefin elastomer, ethylene propylene diene monomer and cis-1,4-polybutadiene rubber.

4. The preparation method of an organic gel phase change material with a double crosslinked network according to claim 3, wherein the styrene block copolymer is a mixture of one or more of a styrene butadiene styrene block copolymer, styrene isoprene styrene block copolymer, styrene ethylene/butylene styrene block copolymer, and styrene ethylene/propylene styrene block copolymer.

5. The preparation method of an organic gel phase change material with a double crosslinked network according to claim 1, wherein a heating temperature in step S2 is 80-100° C.

6. The preparation method of an organic gel phase change material with a double crosslinked network according to claim 5, wherein the heating temperature in step S2 is lower than a flash point of the organic phase change material.

7. The preparation method of an organic gel phase change material with a double crosslinked network according to claim 1, wherein the crosslinking agent is a bifunctional or multifunctional small molecular compound.

8. The preparation method of an organic gel phase change material with a double crosslinked network according to claim 1, wherein the UV initiator is a mixture of one or more of dibenzoyl, alkylphenylketones, and benzoyl phosphine oxide.

9. The preparation method of an organic gel phase change material with a double crosslinked network according to claim 1, wherein the nucleating agent is a high melting point organic matter or a dispersible micron inorganic matter that is fused with the organic phase change material.

10. An organic gel phase change material with a double crosslinked network, which is prepared by the preparation method of an organic gel phase change material with a double crosslinked network according to claim 1.
